(19) United States
(12) Patent Application Publication
(10) Pub. No.: US 2024/0420309 A1
(43) Pub. Date: Dec. 19, 2024

(54) SYSTEM AND METHOD FOR GRADING, PROCESSING, AND LOADING LOGS

(71) Applicant: Hendtech LLC, Simpsonville, SC (US)

(72) Inventor: Andrew Henderson, Simpsonville, SC (US)

(21) Appl. No.: 18/741,398

(22) Filed: Jun. 12, 2024

Related U.S. Application Data
(60) Provisional application No. 63/521,113, filed on Jun. 15, 2023.

(51) Int. Cl. G06T 7/00; G01N 21/88; G06T 7/20; G06T 7/60; G06V 10/764

(52) U.S. Cl. CPC G06T 7/0008; G01N 21/8851; G06T 7/20; G06T 7/60; G06V 10/764; G01N 2021/8874; G06T 2207/30161; G06V 2201/07

(57) ABSTRACT

A processing system is provided for analyzing a log under evaluation. The processing system includes a camera, processor(s), and memory device(s). The memory device(s) include computer readable code configured, when executed, to cause the processor(s) to receive images from the camera, to identify the log under evaluation within the images, to estimate dimensions of the log under evaluation, and to determine a log class for the log under evaluation. The computer readable code may be configured to cause the processor(s) to utilize machine learning technique(s), and the dimensions of the log under evaluation may be determined using photogrammetry. The computer readable code may be configured to cause the processor(s) to detect variation(s) in the log under evaluation such as feature deviating from a conical frustrum shape, a defect, a surface variation, a crook, a sweep, or a fork.

### CROSS-REFERENCE TO RELATED APPLICATION(S)

This application claims priority to U.S. Provisional Patent Application No. 63/521,113, filed Jun. 15, 2023, entitled “SYSTEM AND METHOD FOR GRADING, PROCESSING, AND LOADING LOGS,” which is hereby incorporated by reference in its entirety.

### FIELD

Embodiments relate generally to log processing systems for identifying characteristics of logs so that they may be positioned in an appropriate class.

### BACKGROUND

A loader operator on a logging crew is a skilled individual who operates a knuckleboom loader and who makes critical decisions affecting use and value of wood products. More particularly, the loader operator has the responsibility to provide consistent and accurate log grading. That individual is responsible for identifying and characterizing higher-value and lower-value wood products, allowing for appropriate sales of each. Hiring, training, and retaining loader operators in the logging industry is expensive and time consuming.

Furthermore, a loader operator is prone to make mistakes in identifying characteristics of logs, leading to misclassifications of logs. For example, logs may be incorrectly classified in terms of the type of wood, the size and shape of the wood, or the quality of the wood. Where the misclassification goes undetected, this leads to a reduction in quality of wood products that are formed. Alternatively, misclassification of logs results revenue losses and inefficiencies. For example, where a misclassification is detected, this leads to further inefficiencies because waste is created and must be managed. Misclassifications of logs in logging operations leads to lost revenue and inefficient use of harvested wood. For example, high-quality or high-value wood products may be mixed with low-quality or low-value wood products, resulting in a lost opportunity cost on sale of the high-value wood products.

As another example, if a pulpwood log is delivered to a higher-value wood mill, the inspector for the mill may potentially cull the pulpwood log to reduce the weight of the load, receiving less pay for the pulpwood log. A mill may process the pulpwood log but only create byproducts. The byproducts will be used in alternative markets, but transportation and processing of the log will likely be inefficient. In extreme cases the inspector may decline an entire load. In these wasteful and expensive cases, the effort to load and transport the logs is drastically increased-three times the effort or more may be required.

The current state of the art for merchandising logs is human vision and knowledge. In some regions, specialized machines are used to measure trees or logs, by contact, and process them into logs. These machines represent significant capital expenditures, require specialized labor, are less productive than conventional human vision-based logging, and cannot detect visual variations or species.

Mills purchase wood based on the tonnage of a load. Common categories of wood products are sawtimber, chip-n-saw, and pulpwood, with sawtimber being the highest value and pulpwood the lowest. Other categories exist such as energywood, plylogs, and power poles. Pulpwood is the least restrictive category because it is processed into pulp. Sawtimber and chip-n-saw are processed into dimensional lumber. Market effects (e.g., housing starts) fluctuate demand for dimensional lumber and cause the price of sawtimber and chip-n-saw to fluctuate. Pulp is diverse and used in paperboard products (e.g., packaging and shipping boxes), health and hygiene products (e.g., tissues, paper towels, and diapers), and textile (e.g., rayon). Pulpwood prices vary by local competition with other products, such as energywood.

### BRIEF SUMMARY

Through ingenuity and hard work, the inventor has invented a new and innovative approach to enable proper classifications of logs in logging operations as well as train knuckleboom loader operators. Log processing systems and methods for using the same have been developed. In various embodiments, log processing systems may provide guidance for cutting logs and for optimizing log sections based on grade, value, and presence/location of variations. In some embodiments, log processing systems may be configured to operate using an artificial intelligence-enhanced vision system that will provide guidance for classifying and processing wood products, as well as loading products onto trailers at a harvesting site.

In an embodiment, the invention comprises a log processing system which enables any loader operator to grade, process, and load wood products at a level better than even expert loader operators. The log processing system may lead to a reduction in new operator training by at least fifty percent, improving revenues. The log processing system may also ensure that harvested resources are utilized effectively. In an embodiment, the log processing system expands the logging workforce because barriers to entry are lowered. The log processing system may also improve revenues within the timber supply chain, and the log processing system may also provide downstream efficiencies without reducing logger efficiencies or production rates. In some embodiments, the log processing system may be added to machines that are used to measure logs by contact. In doing so, these machines may be made even more accurate.

Embodiments described herein may allow characteristics such as a large end diameter (LED), a length, a taper, a species, and an estimated weight to be identified for each individual logs or a portion thereof. Embodiments may enable localization and classification of variations such as cankers, scars, knots, equipment damage, rot, red heart, blue stain, off-centered wood, crooks, sweeps, and fork. Depending on a size and location of a variation, an entire log can be salvaged, or a portion of a log may be salvaged.

Systems are configured to provide consistent performance regardless of circumstances. For example, as environmental conditions change, the systems may still perform at a consistent level. Even with differing lighting due to the movement of the sun, passing clouds, dust and debris, and precipitation, the systems may still operate at a high level of effectiveness. Additionally, as objects move around the work area such as other construction equipment, other human operators, and other materials, the systems may still operate at a high level of effectiveness. The systems may also work effectively even in harsh environments containing a large amount of dust, debris, and harsh vibrations. Even where the systems are installed on different types of equipment and different machines, the systems may work effectively. Systems may be configured to operate in remote environments where internet connectivity is either unavailable or unreliable.

Various embodiments described herein provide specific technological solutions to technological problems. As a first example, the analysis engine unit may be configured to detect dynamic, moving objects within a work area through the use of a multi-object tracking and segmentation (MOTS) model. This MOTS model may allow for tracking of logs in multiple frames of video feeds. Systems may track an individual log through multiple frames of video while evaluating and collecting characteristics, so enhanced tracking may make determinations of characteristics for logs more accurate and more precise. Embodiments may enable a dimensional precision of about one inch at a visual depth of about 30 feet or even a dimensional precision of about 0.5 inches at a visual depth of about 30 feet, and log processing systems may be configured to evaluate characteristics of logs and detect variations within about one second of initial observation with a camera.

Embodiments may include an analysis engine unit that is configured to deploy a dimensions estimation model. The analysis engine unit may be configured to accurately measure dimensions for a log despite changes in object orientation and position relative to camera(s). Monoscopic photogrammetry may be used to measure and derive three-dimensional information from two-dimensional photographs taken from a single vantage point, relying on understanding and applying principles of perspective and geometry to extract spatial data from a single image. However, stereoscopic photogrammetry may be used in some embodiments, with stereoscopic photogrammetry using images from multiple angles.

Additionally, embodiments may utilize Bayesian updating to prevent dramatic changes in class prediction for a log from one evaluation to the next. This may, for example, prevent a log from being classified as having a very low quality after multiple variations are detected on the log and then subsequently being upgraded to a classification as having a very high quality when variations are no longer visible due to the pose of the log relative to cameras.

In some embodiments, the log processing system may also be configured to assist in converting logs into wood products or smaller wood logs, thereby transforming the logs into a different state. The log processing system may be utilized in conjunction with loader equipment and other equipment to help effectuate this transformation.

In an example embodiment, a log processing system is provided for analyzing a log under evaluation. The log processing system includes a camera, one or more processors, and one or more memory devices comprising computer readable code. The computer readable code is configured, when executed, to cause the one or more processors to receive images from the camera, to identify the log under evaluation within the images, to estimate dimensions of the log under evaluation, and to determine a log class for the log under evaluation.

In some example embodiments, the computer readable code may be configured, when executed, to cause the one or more processors to utilize one or more machine learning techniques. Additionally, in some embodiments, the computer readable code may be configured, when executed, to cause the one or more processors to utilize one or more machine learning techniques to perform at least one of identifying the log under evaluation within the images, estimating the dimensions of the log under evaluation, determining the log class for the log under evaluation, detecting and classifying a variation within the log under evaluation, detecting and classifying an object within the images using multi-object tracking and segmentation, and tracking of a weight for a log. Furthermore, in some embodiments, the dimensions of the log under evaluation may be determined using photogrammetry. In some embodiments, the dimensions of the log under evaluation may be determined with a dimensional precision of about 0.5 inches or less at a visual depth of about 30 feet from the camera. Additionally, in some embodiments, the dimensions of the log may be detected within less than about one second of initial observation by the camera.

In some embodiments, the computer readable code may be configured, when executed, to cause the one or more processors to detect one or more variations in the log under evaluation. Additionally, in some embodiments, the one or more variations may include a feature that deviates from a conical frustrum shape, a defect, a surface variation, a crook, a sweep, or a fork.

In some embodiments, the computer readable code may be configured, when executed, to cause the one or more processors to detect the log under evaluation within a work area using multi-object tracking and segmentation. Additionally, in some embodiments, the computer readable code may be configured, when executed, to cause the one or more processors to detect another moving object within the work area using multi-object tracking and segmentation.

In some embodiments, the computer readable code may be configured, when executed, to cause the one or more processors to sort the log under evaluation based on the log class. In some embodiments, the computer readable code may be configured, when executed, to cause the one or more processors to estimate a weight of each log, and the determination of the log class for the log under evaluation may be dependent upon the weight that is estimated. Also, in some embodiments, the computer readable code may be configured, when executed, to cause the one or more processors to use Bayesian updating to determine the log class for the log under evaluation.

In some embodiments, the computer readable code may be configured, when executed, to cause the one or more processors to emphasize a representation of the log under evaluation within a display image and to cause the display image to be presented on a display. The computer readable code may also be configured, when executed, to cause the one or more processors to cause detailed information regarding the log under evaluation to be presented in the display.

In another example embodiments, a system for analyzing a log under evaluation is provided. The system comprises logging equipment. The logging equipment may be at least one of a loader, bucking equipment configured to cut a log into one or more smaller logs, or a delimber configured to remove limbs from the log. The system also comprises a camera and a log processing system. The log processing system comprises one or more processors and one or more memory devices that includes comprising computer readable code. The computer readable code is configured, when executed, to cause the one or more processors to receive images from the camera, identify the log under evaluation within the images, estimate dimensions of the log under evaluation, and to determine a log class for the log under evaluation.

In some embodiments, the logging equipment may include the loader, and the computer readable code may be configured, when executed, to cause the one or more processors to send loading instructions to the loader and to cause the logging equipment to load the logs in accordance with the loading instructions. Additionally, in some embodiments, the logging equipment may include the bucking equipment, and the computer readable code may be configured, when executed, to cause the one or more processors to send bucking instructions to the bucking equipment and to cause the bucking equipment to cut the log in accordance with the instructions.

In some embodiments, the system may also include a display. Additionally, the computer readable code may be configured, when executed, to cause the one or more processors to emphasize a representation of the log under evaluation within a display image and to cause the display image to be presented on the display.

In another example embodiment, a method for analyzing a log under evaluation is provided. The method comprises receiving images from the camera, identifying the log under evaluation within the images, estimating dimensions of the log under evaluation, and determining a log class for the log under evaluation. In some embodiments, the method may also include detecting the log under evaluation within a work area using multi-object tracking and segmentation, detecting one or more variations in the log under evaluation, estimating a weight of each log, and causing the log under evaluation to be sorted based on the log class. The determination of the log class for the log under evaluation may be dependent upon the weight that is estimated, the type of variations in the log under evaluation, the number or size of variations in the log under evaluation.

### BRIEF DESCRIPTION OF THE DRAWINGS

Reference will now be made to the accompanying drawings, which are not necessarily drawn to scale, and wherein:

FIG. 1 illustrates an example loader configured to load logs into a delimber, in accordance with some embodiments discussed herein;

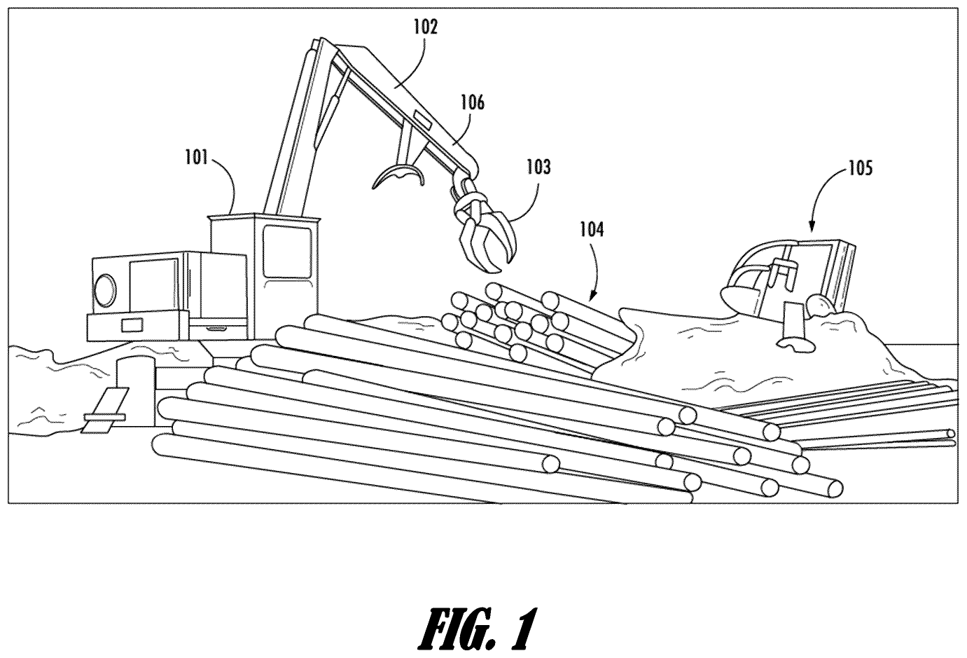

FIG. 2 illustrates an example screen that may be presented to a loader operator, in accordance with some embodiments discussed herein;

FIG. 3 is a schematic view illustrating an example log and dimensions therefore, in accordance with some embodiments discussed herein;

FIGS. 4A-4C are schematic views illustrating an example crook, sweep, and fork respectfully, which each may be present in a log, in accordance with some embodiments discussed herein;

FIG. 5 is a block diagram illustrating components within an example log processing system, in accordance with some embodiments discussed herein;

FIG. 6A is a flow chart illustrating an example method for processing a log, in accordance with some embodiments discussed herein;

FIG. 6B is a flow chart illustrating an example method for loading a log, in accordance with some embodiments discussed herein; and

FIG. 7 is a flow chart illustrating an example method for operating a log processing system, in accordance with some embodiments discussed herein.

### DETAILED DESCRIPTION

Example embodiments now will be described more fully hereinafter with reference to the accompanying drawings, in which some, but not all embodiments are shown. Any connections or attachments may be direct or indirect connections or attachments unless specifically noted otherwise. As used herein, “variations” include features that deviate from a conical frustrum shape, and variations may include defects, surface variations, crooks, sweeps, forks, and other features deviating from a conical frustrum shape.

As used herein, a “log” includes trees that have been cut down and/or portions thereof, regardless of whether or not they have undergone further processing (e.g., delimibing, bucking, sorting, loading, etc.). While embodiments below are generally described as being used with logs, these embodiments may also be used with trees as well.

A loader operator may operate the loader equipment 102, which may be a knuckleboom loader. The loader equipment 102 comprises a loader arm 106 with a grapple 103 positioned at the end of the loader arm 106. A loader operator may be positioned inside a cab 101 of the loader equipment 102, and the loader operator may cause the loader equipment 102, the loader arm 106, and the grapple 103 to move from within the cab 101. The loader equipment 102 may be used to pick up logs 104 using the grapple 103 and the loader arm 106. Once the logs 104 have been picked up, the logs 104 may be inserted into the delimber machine 105. The delimber machine 105 may be configured to remove limbs that may be present on the logs 104 and to trim the top of the logs 104, thereby creating logs that meet specifications of mills. After going through the delimber machine 105, logs may be sorted into different piles based on the characteristics of the log. These characteristics may include the type of wood within the log, the size and dimensions of the log, the shape of the log, etc. The loader and the delimber may be integrated into a single machine. These machines are available such as those provided by John Deere, Caterpillar, Tigercat, and other companies. The delimber machine 105 may include cutting equipment such a cutting blade that is configured to remove limbs from a log, and the delimber machine 105 may include a saw for cutting the top of a log or a tree.

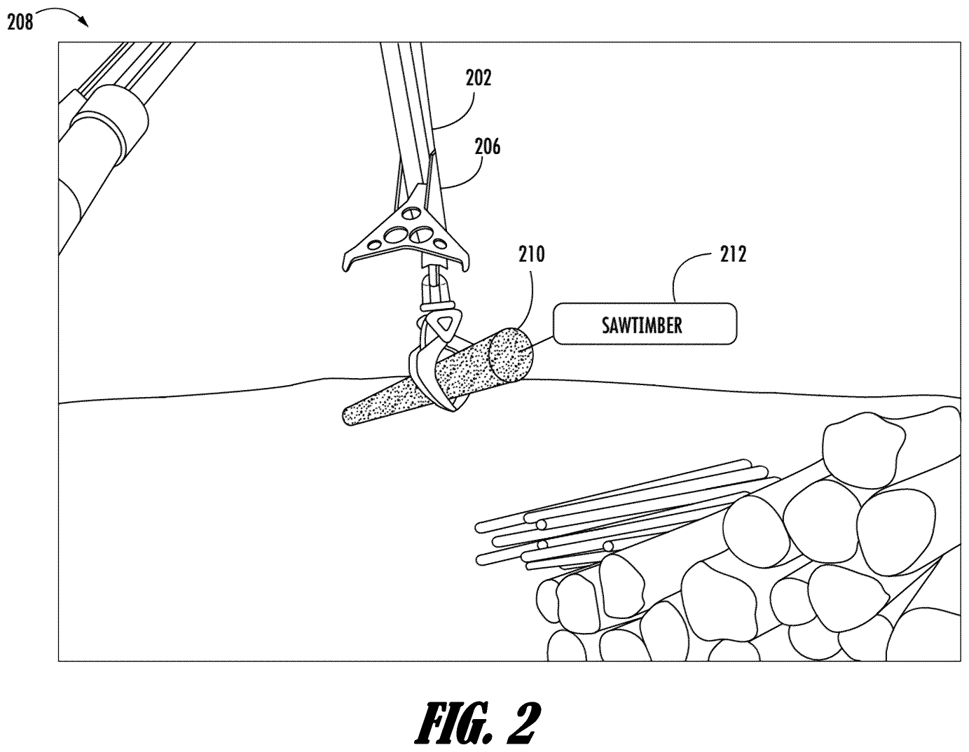

FIG. 2 illustrates an example screen 208 that may be presented to a loader operator. The screen 208 may be presented in a display positioned within the cab 101 of loader equipment 102. The screen 208 may be configured to provide visual feedback to a loader operator to distinguish a representation 210 of a log relative to other material on the screen 208. Representations of the loader equipment 202 and the loader arm 206 are also illustrated on the screen 208. The material presented on the screen may be video of the environment (e.g., real-time video), and the representation 210 of the log may be where the log is shown in the video.

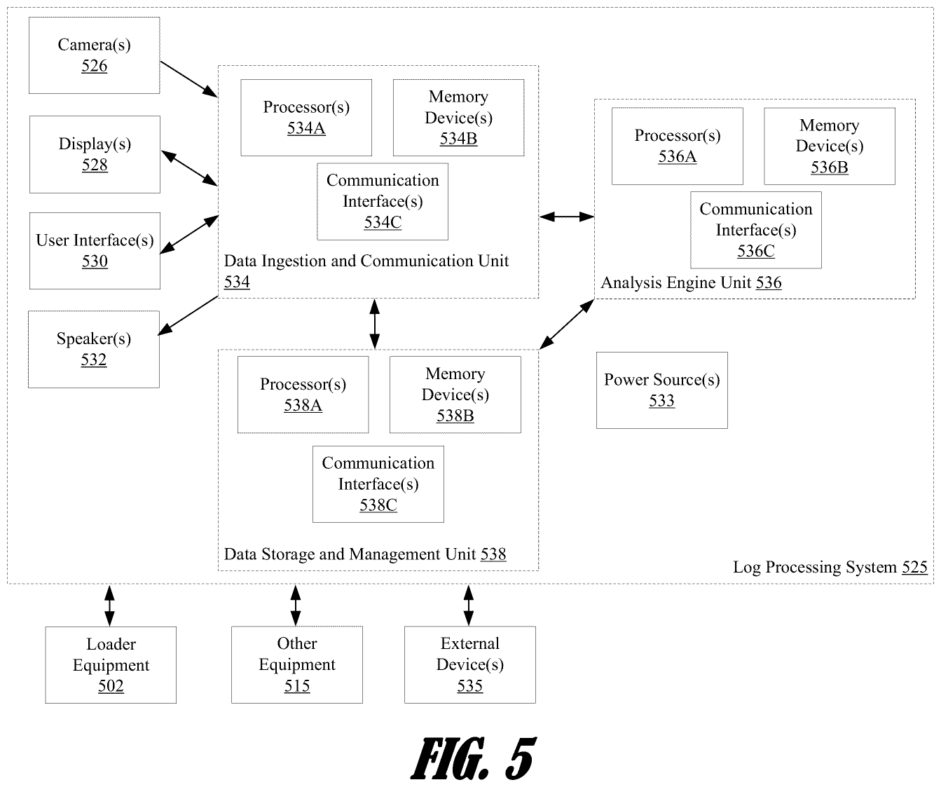

Systems described herein may track a log from the moment that the loader arm 206 grasps the log until the log is placed in a sorted pile. One or more cameras may be utilized to obtain images so that the position of the log within the environment may be detected. The analysis engine unit 536 (see FIG. 5) may be configured to identify the log within the images, with the boundaries of the log being detected. The analysis engine unit 536 (see FIG. 5) may be configured to detect one or more characteristics of the log as the log is tracked. Based on the detected boundaries of the log, an emphasis of the representation 210 of the log in the images may be presented on the display. This emphasis may be highlighting of the representation 210 in one or more colors (e.g., blue), presenting an outline around the perimeter of the representation, blurring other objects within the screen without blurring the representation, etc. Additionally, based on the detected characteristic(s) of the log, a representation 212 may be presented to indicate characteristic(s) for the log. The representation 212 indicates that the log comprises sawtimber, but the representation 212 may include different or additional information in other embodiments. For example, the representation 212 may include the type of wood, any detected variations in the wood, the location of variations in the wood, the dimensions of the wood, etc. The representation 212 appears as a pop-up window positioned proximate to the representation 210 in the screen 208 of FIG. 2, but the representation 212 may be presented in another manner in other embodiments.

As noted herein, an analysis engine unit of a log processing system 525 may be configured to detect dynamic, moving objects (e.g., the log associated with the representation 210) within a work area through the use of a multi-object tracking and segmentation (MOTS) model. Once dynamic, moving object(s) are detected, a specific log that is currently being evaluated may be identified, and a representation (e.g., representation 210) may be presented on the screen 208 to emphasize that log.

The systems described herein may be used to assist with training knuckleboom loader operators. As knuckleboom loader operators use the system, the knuckleboom loader operators may learn from the information identified by the system. For example, the system may detect certain variations on a log, dimensions of the log, the type of wood in the log, etc., and the system may share this information with the loader operator. As the loader operator receives this guidance from the system, the loader operator may become better equipped over time to identify characteristics of the log on his or her own.

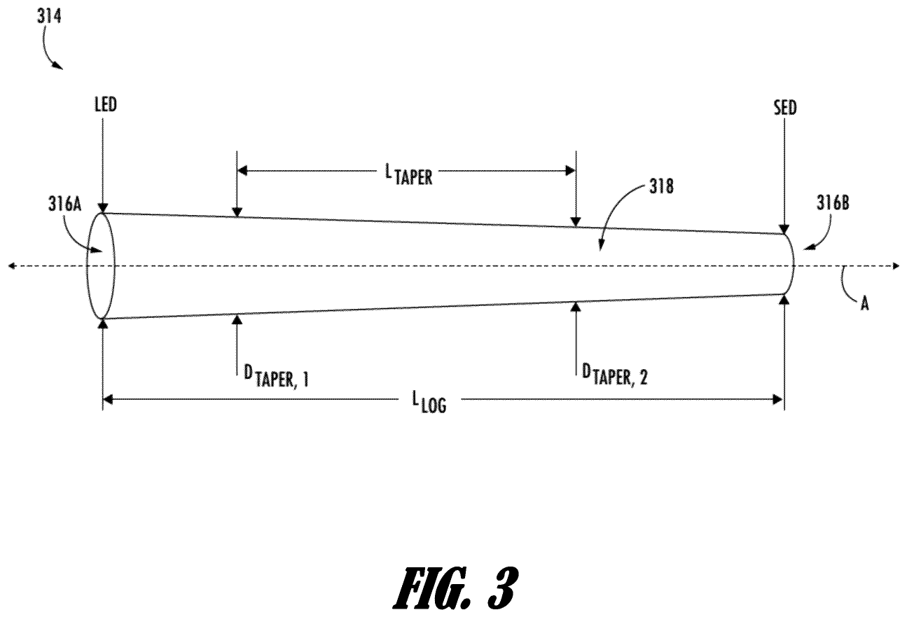

An example log 314 and dimensions therefore are illustrated in the schematic view of FIG. 3. As noted herein, FIG. 3 is not drawn to scale. While a log 314 is illustrated in FIG. 3, a log may generally share the same dimensions.

The example log 314 is illustrated with a conical frustum shape that is typical of most logs. The log 314 comprises an end faces 316A, 316B and a side face 318. The first end face 316A has a larger diameter (LED) than the diameter (SED) of the second end face 316B. The end faces 316A, 316B may possess variations such as rot, red heart, and blue stains, and the end faces 316A, 316B may also be off-center or uneven. Issues such as rot, red heart, blue stain, and the off-centered or uneven geometry of logs may be identified based on the color of the log and/or the dimensions of the log.

Variations such as cankers, scars, knots, protrusions, and other damage from equipment may be present at the end faces 316A, 316B or at the side face 318. Each of these variations may be small (e.g, less than about an inch or less than about two inches in length). Damages from equipment may include scars, cuts, gashes, splintering, etc. While different variations are described, other variations may also be present. Additionally, multiple variations may be present in a single log.

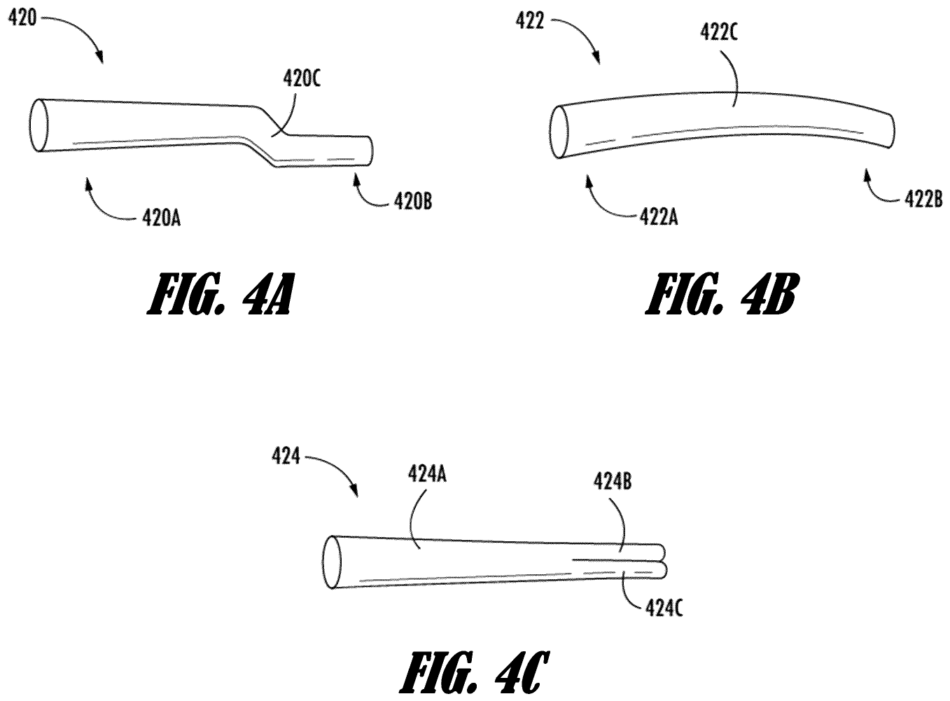

The large-end-diameter (LED) is represented at the first end face 316A, and the small-end-diameter (SED) is represented at the second end face 316B. The log 314 is symmetrical and extends along a central axis A, but other logs 314 may not be symmetrical and may not extend neatly along a central axis A (see, e.g., crook 420 and sweep 422 examples of FIGS. 4A and 4B). The log 314 defines a length (L_{LOG}), with this length being measured along an axis parallel to the central axis A. The log 314 defines a taper, with this taper being the change in diameter per foot of the log 314. The taper may be calculated by identifying the difference between the diameter at a first location (D_{TAPER, 1}) and the diameter at a second location (D_{TAPER, 2}) and then dividing the distance (L_{TAPER}) separating these two points along the central axis A. Thus, the taper may be calculated using the following equation:

$$taper = \frac{( {D}_{T A PER , 1} - {D}_{T A P E R , 2} )}{{L}_{T A P E R}}$$

With a calibrated camera system, consistent object pose, and consistent object position, the conversion from pixel dimensions in image-space to physical dimensions in real-space is trivial. However, this is far from trivial where the pose of the log and the depth of the log from the camera are not consistent from one image to the next. Various embodiments described herein may utilize a geometry-based model using monoscopic photogrammetry to estimate the dimensions of the logs. In some embodiments, the analysis engine unit 536 of FIG. 5 may be utilized to run this geometry-based model using monoscopic photogrammetry, but units other than the analysis engine unit 536 may run this model in other embodiments. Additionally, stereoscopic photogrammetry may be used in some embodiments rather than monoscopic photogrammetry, and the analysis engine unit 536 may be utilized to run a geometry-based model using stereoscopic photogrammetry.

Other types of variations are illustrated in FIGS. 4A-4C. FIGS. 4A-4C illustrate an example crook 420, sweep 422, and fork 424 respectfully, which each may be present in a log. The crooks, sweeps, and forks are each variations from a typical conical frustum shape. With a crook 420, a log may extend between a first end 420A and a second end 420B, and a region 420C may be present between the first end 420A and the second end 420B where the log extends in a direction that is not parallel to the central axis of the log. With the sweep 422, a log may extend between the first end 422A and the second end 422B, and the log may curve and gradually change in direction at central portions 422C as it extends between the first end 422A and the second end 422B. With the fork 424, the body 424A may split into a first portion 424B and a second portion 424C.

Due to the existence of so many different variations and the difficulty of identifying the dimensions of logs, a simpler classification model would likely fail to appropriately categorize logs. A simpler classification model would likely fail to account for and/or identify all of the different types of variations that may be present in logs, making this classification model less effective in determining the quality of the logs. The log processing system 525 may utilize an object detection model instead of a simpler classification model.

FIG. 5 is a block diagram illustrating components within an example log processing system 525. The log processing system 525 may comprise one or more cameras 526. The cameras may be configured to provide a real-time video feed of locations around the log processing system 525. Where multiple cameras are used, the cameras may capture video and/or images of different areas within an environment. For example, a first camera may be configured to view an area to the front of a loader cab, a second camera may be configured to view an area to the left of the loader cab, and a third camera may be configured to view an area to the right of the loader cab.

Additionally or alternatively, where multiple cameras are utilized, the cameras may capture video and/or images from different angles so that positions of logs and other components may be more accurately determined. For example, a first camera may be configured to view an area to the front of a loader cab from a first angle, and a second camera may be configured to view an area to the front of the loader cab from a second angle. By capturing video and/or images from different angles, the log processing system 525 may better determine the position and/or orientation of components with improved depth-perception, allowing the log processing system 525 to better determine the distance of logs and other objects from the loader cab.

Dimensions and characteristics for a log may be estimated using monoscopic photogrammetry or stereoscopic photogrammetry in some embodiments. Monoscopic photogrammetry may be used to measure and derive three-dimensional information from two-dimensional photographs taken from a single vantage point (e.g., from a single camera). Monoscopic photogrammetry may rely on understanding and applying principles of perspective and geometry to extract spatial data from a single image. This method contrasts with stereoscopic photogrammetry, which uses images from multiple angles (e.g., from multiple cameras). Monoscopic photogrammetry is often used in applications where only one image is available. Capturing images of a log from different angles may be beneficial to enable identification of variations. For example, some variations may not be visible at a camera viewing a log from a first angle, but the same variations may be visible from a camera viewing the log from a second angle.

The log processing system 525 may comprise one or more speakers 532. The speaker(s) 532 may be configured to communicate notification alerts, feedback, instructions, etc. to a loader operator.

The log processing system 525 may comprise one or more displays 528, and the log processing system 525 may comprise one or more user interfaces 530. The user interface(s) 530 may be configured to enable the logging operations manager and/or the loader operator to input load information. In some embodiments, the display(s) 528 may themselves serve as the user interface(s) 530. For example, the display(s) 528 may include one or more touch-screen display(s), allowing user inputs to be received based on touch commands by the user on the touch-screen display(s). The display(s) 528 and/or the user interface(s) 530 may be configured to prompt users to provide certain inputs, and the display(s) 528 and/or the user interface(s) 530 may be configured to receive inputs from users.

The display(s) 528 and/or the user interface(s) 530 may be configured to provide haptic feedback to the user in some embodiments. For example, where a user touches display(s) 528 that are touch screen display(s) or where the user otherwise interacts with user interface(s) 530 to input information, the display(s) 528 or the user interface(s) 530 may vibrate or generate some other similar movement to provide haptic feedback to the user, thereby confirming that the inputs of the user have been detected. Additionally or alternatively, the display(s) 528 and/or the user interface(s) 530 may be configured to provide visual feedback to the user in some embodiments. For example, where a user touches display(s) 528 that are touch screen display(s) or where the user otherwise interacts with user interface(s) 530 to input information, the display(s) 528 may provide a visual indication (e.g., a pop up screen, a change in color, a flash, a notification, etc.) or the user interface(s) 530 may provide a visual indication (e.g., flashing light, flashing light on button itself, etc.) to provide visual feedback to the user, thereby confirming that the user's inputs have been detected. Other feedback may be provided to the user as well (e.g., audio feedback via speaker(s) 532).

The camera(s) 526, display(s) 528, user interface(s) 530, speaker(s) 532, and other components illustrated in FIG. 5 may be rugged and may be configured to be used in harsh environments where these components may be exposed to dust, debris, precipitation, humidity, etc. These components may be appropriately sealed in some embodiments using O-rings or other scaling approaches.

The log processing system 525 may comprise a data ingestion and communication unit 534. The data ingestion and communication unit 534 may include one or more processors 534A, one or more memory devices 534B, and one or more communication interfaces 534C. The data ingestion and communication unit 534 may be configured to receive material from the camera(s) 526, the display(s) 528, and user interface(s) 530. Once this information is received at the data ingestion and communication unit 534, the data ingestion and communication unit 534 may be configured to parse this material so that this material is presented in a format that the analysis engine unit 536 is readily capable of understanding. In some embodiments, the data ingestion and communication unit 534 may also be configured to cause changes to be made at the camera(s) 526, display(s) 528, user interface(s) 530, and the speaker(s) 532. While the communication between camera(s) 526 and the data ingestion and communication unit 534 and the arrows between speakers 532 and the data ingestion and communication unit 534 are one-directional as indicated by the one-directional arrows, two-way communication may occur between these components in some embodiments so that signals are sent in both directions.

The log processing system 525 may comprise an analysis engine unit 536. The analysis engine unit 536 may include one or more processors 536A, one or more memory devices 536B, and one or more communication interfaces 536C. The analysis engine unit 536 may be configured to utilize one or more different models. These models include a multi-object tracking and segmentation (MOTS) model, a log-under-evaluation (LUE) model, a variation detection model, a dimensions estimation model, a log class (LC) model, a weight and load tracker (WLT) model, a machine learning model, and/or a deep learning model. These models are described in greater detail below.

The analysis engine unit 536 may be configured to detect dynamic, moving objects (e.g., logs, a loader arm or a grapple attached thereto, or other objects) within a work area through the use of a MOTS model. By using MOTS model(s), the analysis engine unit 536 may be configured to establish bounding boxes on objects, classify objects, establish detailed pixel-level segmentation of objects, and track objects between frames.

The analysis engine unit 536 may be configured to deploy a LUE model. The LUE model may utilize bounding boxes and object classes from the MOTS model to identify a specific log that is being evaluated. There may be multiple logs, and other objects within a field-of-view for a camera, and the MOTS model is likely to detect all of these objects. As such, a LUE model is important to discern the specific log from all of the possible options within the frame. In some embodiments, the analysis engine unit 536 may utilize an algorithm that uses context derived from the camera images (e.g., video frames) to identify the log-under-evaluation. However, other techniques may be used. The output is a tracking identification and segmentation mask for the log-under-evaluation.

The analysis engine unit 536 may be configured to estimate dimensional characteristics of a log, estimate a weight of a log, identify the type of wood within a log, and classify a log.

In an embodiment, the analysis engine unit 536 may be configured to detect variations and may be configured to run a variation detection model to do the same. The analysis engine unit 536 may be configured to evaluate the segmented pixels of the log-under-evaluation. Evaluation of these segmented pixels enables the analysis engine unit 536 to localize variations on the log-under-evaluation and classify those variations. Variations that may be identified include rot, red heart, blue stains, off-centered or uneven geometry, cankers, scars, knots, protrusions, and other damage from equipment. The variation detection model may also be configured to track the position of variations as a log and loader equipment move relative to each other,

As a log is being tracked, the analysis engine unit 536 may be configured to deploy the variation detection model to evaluate multiple poses for the log, and the analysis engine unit 536 may also be configured to use the dimensions estimation model to evaluate multiple poses of the log. The memory device(s) 536B of the analysis engine unit 536 may be configured to maintain a short-term memory of each evaluation performed using the variation detection model and the dimensions estimation model, and the analysis engine unit 536 may be configured to continuously update the classification for a log based on these evaluations as further evaluations are performed. For example, if a variation is visible in any pose of the log, the analysis engine unit 536 may identify this variation, retain an indication in memory about the variation (e.g., the identify, location, and type of variation), and incorporate this information into subsequent classifications of the log using the LC model.

The classification for a log may depend upon the dimensions for the log, the shape of the log, the type of wood within the log, the presence or absence of variations, etc., and the dimensions for the log may be particularly important. Thus, the ability to accurately determine the dimensions of a log with a high degree of precision is important. The analysis engine unit 536 may be configured to determine the dimensions of the log with a high degree of accuracy and precision. Dimensions may be precise, with dimensions identified by the analysis engine unit 536 typically being within about 0.5 inches from actual dimensions for a log.

The analysis engine unit 536 may be configured to grade logs based on the characteristics of the logs. The analysis engine unit 536 may be configured to determine or redetermine a grade of a log at a specified frequency. For example, the analysis engine unit 536 may redetermine a grade about one time per second or more, about two times per second or more, etc.

In an embodiment, the analysis engine unit 536 or another component within the log processing system 525 may be configured to utilize an LC model, and the LC model may be configured to determine the class of the log. The LC model may utilize the identified dimensions of a log, the presence of a variation on the log, the location of any variations on the log, and the class of variation(s) to determine the class of the log based on the mill's current specifications. In determining the class, the analysis engine unit 536 may utilize other stored data within a database regarding the classes and characteristics for logs in each class.

The LC model may be configured to determine the highest value use for each possible log-section. As an example, the analysis engine unit 536 may be configured to analyze a log and determine that the log should be bucked (e.g., sawn) into three sawtimber logs and one pulpwood log to obtain the greatest overall value. Once a determination is made about the highest value use, the log processing system 525 may be configured to cause recommendations to be presented to the loader operator or another user at the display(s) 528, with these recommendations providing guidance on how make the appropriate cuts on the larger log to obtain these smaller logs.

The analysis engine unit 536 may also be configured to deploy a WLT model. This WLT model may be deployed when logs are being loaded onto a trailer. The analysis engine unit 536 may be configured to deploy the WLT model to estimate a weight of each log that is loaded onto the trailer. The analysis engine unit 536 may also be configured to deploy the WLT model to ensure that each log that is grouped together is of the same product class. The analysis engine unit 536 may also be configured to deploy the WLT model to track the total weight of logs on a trailer, and this may be beneficial to ensure that the trailer is not loaded beyond certain weight limits imposed by mills or transportation authorities.

The WLT model deployed by the analysis engine unit 536 may use the data obtained from the dimensions estimation model, the variation detector model, and the log class model to determine an appropriate product class. The WLT model may also be configured to estimate a weight of a log based on log volume and industry established volume to weight transfer functions. Separately, the WLT model may also utilize hydraulic system data from a diagnostic port of loader equipment to estimate weight of the log. Based on the estimate of weight from the volume and the estimate of weight from hydraulic system data, the WLT model may determine a best estimate of the actual weight for a log. The WLT model may keep a running sum of the weight estimates for each log that is loaded on the trailer and may output a total estimate that the loader operator may use to ensure that the weight of a load is maximized without exceeding the weight limitations imposed by mills or transportation authorities. Tracking the total weight accurately and precisely is also beneficial to allow for an accurate estimation of the value of logs that are loaded on the trailer. For example, 1000 pounds of logs are typically going to be worth more than 800 pounds of logs within the same class, so accurately and precisely identifying the weight is important to ensure that the full value for logs is obtained.

The analysis engine unit 536 may also be configured to provide guidance for processing logs and for loading logs onto trailers. When providing loading guidance, the log processing system 525 may make determinations based on the grade or classification of logs are being loaded on a trailer. Once the analysis engine unit 536 has information regarding the grade or classifications of logs to load on a particular trailer, the analysis engine unit 536 may be configured to generate instructions to a loader operator as to whether or not the log should be included in a particular load, and, if so, identify the particular load that the log should be positioned on. The analysis engine unit 536 may generate instructions based on the classification for the logs that is determined by the LC model of the analysis engine unit 536.

In one example embodiment, the log processing system 525 may be configured to use a Bayesian update routine for dimension estimates. This Bayesian update routine may be executed by the analysis engine unit 536 as the analysis engine unit 536 deploys a dimensions estimation model. For example, a prior probability for a certain characteristic (e.g., log class, likelihood of variation being present, a dimension, etc.) may be established based on the first view of the log. After one or more additional poses are analyzed and additional data is captured, the prior probability may be updated to form a posterior probability. As further poses are analyzed and even further additional data is captured, the posterior probability may then be used as the prior probability for the next iteration of inference. The probability obtained from use of the Bayesian update routine may be utilized to classify logs, preventing dramatic changes in the class prediction from one evaluation to the next. The probability that is updated over time through this Bayesian update routine may be utilized in other ways as well. For example, the probability may be used to identify the presence of variations on the log and the probability thereof, the class or grade that the log should be given, the location of the variations, the dimensions, etc.

The analysis engine unit 536 may utilize artificial intelligence and/or machine learning techniques. As used herein, the terms “machine learning” or “machine learning model” are intended to mean the application of one or more software application techniques that process and analyze data to draw inferences from patterns in the data. Machine learning techniques can process and analyze data to enable computer systems to autonomously learn and improve their performance over time from the data, to automatically identify patterns, extract insights, and make informed decisions or predictions without explicit programming for each scenario. The machine learning techniques can include a variety of artificial intelligence (AI) and machine learning (ML) models or algorithms, including supervised learning techniques, unsupervised learning techniques, reinforcement learning techniques, knowledge-based learning techniques, natural-language-based learning techniques such as natural language generation, natural language processing (NLP) and named entity recognition (NER), deep learning techniques, and the like. The machine learning techniques are trained using training data. The training data may be used to modify and fine-tune any weights associated with the machine learning models, as well as record ground truth for where correct answers can be found within the data. As such, the better the training data, the more accurate and effective the machine learning model.

In some embodiments, the analysis engine unit 536 may be configured to determine a grade utilizing a system of models that includes deep learning model(s). Deep learning models may utilize neural networks with multiple layers to automatically learn relationships between input data and outputs. The neural networks may include interconnected nodes, or “neurons,” organized into layers. Each connection between neurons may be assigned a weight that determines the strength of the signal being transmitted. By adjusting the weights based on input data and desired outcomes, neural networks may learn complex patterns and relationships within the data. The neural networks may include feedforward neural networks (FNNs), convolutional neural networks (CNNs), recurrent neural networks (RNNs), long short-term memory (LSTM) networks, gated recurrent units (GRUs), autoencoders, generative adversarial networks (GANs), transformers, and the like.

The analysis engine unit 536 may be configured to utilize one or more machine learning techniques to perform various tasks described herein. For example, the analysis engine unit 536 may be configured to utilize machine learning technique(s) to assist with dimensions estimation, detection of variations, multi-object tracking and segmentation, determining which log is under evaluation, optimizing log classes, and tracking of a weight and load for a log.

The log processing system 525 may comprise a data storage and management unit 538. The data storage and management unit 538 may include one or more processors 538A, one or more memory devices 538B, and one or more communication interfaces 538C. The log processing system 525 may include a database that contains information about the different loads, classifications, logs, known variations, and other information about logs. In some embodiments, the database may be positioned within the memory device(s) 538B of the data storage and management unit 538, and the analysis engine unit 536 may frequently interact with the data storage and management unit 538 to obtain data from the database where this is the case. In other embodiments, the database may be positioned in one or more external devices 535 (e.g., one or more servers, one or more other types of memory devices, etc.), with these external device(s) 535 being remote from the log processing system 525. In some embodiments, the database may be positioned in the memory device(s) 536B of the analysis engine unit 536, but the database may also be positioned at other locations.

External device(s) 535 may include one or more servers or one or more remote computing devices positioned at a remote location from the log processing system 525. In some embodiments, the external device(s) 535 may be used to update software within the log processing system 525, with software updates being sent from the external device(s) 535 to the log processing system 525 so that these software updates may be downloaded.

The processor(s) 534A, 536A, 538A may be any means configured to execute various programmed operations or instructions stored in a memory device (e.g., memory devices 534B, 536B, 538B) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor(s) 534A, 536A, 538A as described herein.

In an example embodiment, the memory devices 534B, 536B, 538B may include one or more non-transitory storage or memory devices such as, for example, volatile and/or non-volatile memory that may be either fixed or removable. The memory devices 534B, 536B, 538B may be configured to store instructions, computer program code, log data (including data regarding variations and locations thereof, dimensions, log shapes, etc.), location data, and additional data in a non-transitory computer readable medium for use, such as by the processor(s) 534A, 536A, 538A for enabling the components of the log processing system 525 to carry out various functions in accordance with example embodiments of the present invention. For example, the memory devices 534B, 536B, 538B may be configured to buffer input data for processing by the processor(s) 534A, 536A, 538A. Additionally or alternatively, the memory devices 534B, 536B, 538B could be configured to store instructions for execution by the processor(s) 534A, 536A, 538A. The memory devices 534B, 536B, 538B may include computer program code that is configured to, when executed, cause processor(s) 534A, 536A, 538A to perform various methods described herein. The memory devices 534B, 536B, 538B may serve as non-transitory computer readable mediums having stored thereon software instructions that, when executed by one or more processors, cause methods described herein to be performed.

The communications interfaces 534C, 536C, 538C may be configured to enable communication to other components of the log processing system 525, to loader equipment 502, or to external device(s) 535. The communications interfaces 534C, 536C, 538C may also include one or more communications modules configured to communicate with one another in any of a number of different manners including, for example, via wired connections. However, communications interfaces 534C, 536C, 538C may be configured to communicate with one another in other ways such as via a network. In this regard, the communications interfaces 534C, 536C, 538C may include any of a number of different communication backbones or frameworks including, for example, Ethernet, global positioning system (GPS), cellular, Wi-Fi, or other suitable networks. In some embodiments, some or all of the communications interfaces 534C, 536C, 538C, may be configured to communicate using short-range wireless technologies such as Bluetooth (e.g., Bluetooth Version 4.1 or another version), Wi-Fi, NearLink, near-field communication (NFC), low power wide area networks (LPWAN), ultra-wideband (UWB), wireless local area network (WLAN) in accordance with IEEE 802.11 (b), IEEE 802.11 (g), and/or IEEE 802.11 (n) standards, and/or low-rate wireless personal access networks (LR-WPAN) pursuant to the IEEE 802.15.4 standard.

Modules and/or units disclosed herein can also refer to a processor, portions of a processor, computer program and/or the processor/special circuitry that implements that functionality. Elements, modules, units, and components described herein may be further divided into additional components or joined together to form fewer components for performing the same functions. For example, units 534, 536, 538 may be combined together (e.g., in a single, physical device) in some embodiments. Further, selected user interfaces (e.g., windows or screens) can be generated by any selected portion or unit. Further, any of the functions disclosed herein may be implemented using means for performing those functions. Such means include, but are not limited to, any of the components disclosed herein, such as the electronic or computing device components described herein.

The log processing system 525 and each of its components may be mounted to loader equipment 502 in some embodiments. The loader equipment 502 may be similar to the other loader equipment described herein. However, in other embodiments, some of the components of the log processing system 525 may be positioned at a location that is remote from the loader equipment 502. Where components of the log processing system 525 are mounted to the loader equipment 502, these components may be mounted or installed such that they do not block or distract the view of a person that is operating the loader equipment 502.

The log processing system and each of its components may be mounted to other equipment 515 in some embodiments, with this other equipment 515 being logging equipment such as bucking equipment, delimbers, or other equipment. Bucking equipment may include devices with blades that are configured to cut logs. Bucking equipment may include saws, chainsaws, and other devices comprising a cutting blade.

The log processing system 525 may comprise one or more power sources 533. However, the power source(s) 533 may be positioned at a location away from the log processing system 525 in some embodiments. The power source(s) 533 may be configured to provide electrical power to the various components within the log processing system 525, and the power source(s) 533 may be provided in many different forms.

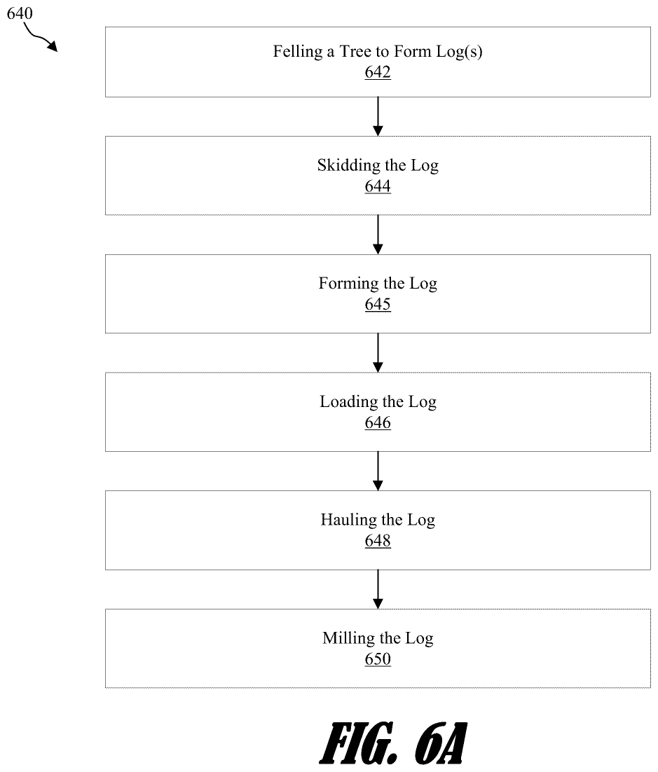

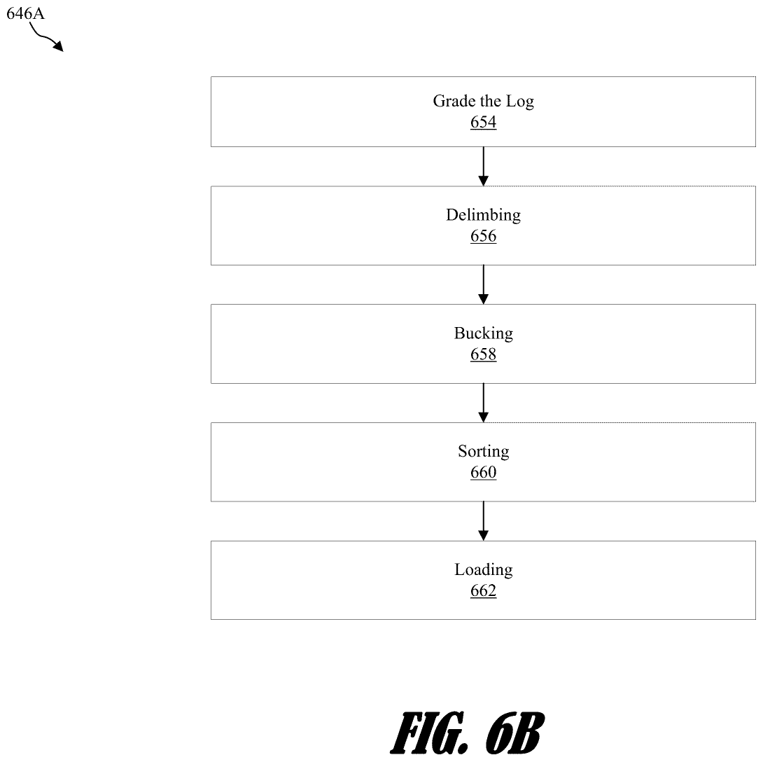

FIG. 6A is a flow chart illustrating one example method 640 for harvesting a tree. At operation 642, a tree may be felled, with the above-ground portion of the tree being severed from a base of the tree to form a log. At operation 644, the log may then be skidded or transported to a loader for loading. At operation 645, the log may be formed. At operation 646, a loading operation is performed. An example method for loading a log is illustrated in FIG. 6B and described in greater detail below. During loading, a log may be graded, processed, and loaded into trailers according to mill needs. The log may be processed by delimbing the log, topping the log, and bucking the log, and the log may be processed differently based on how the log is categorized. At operation 648, the log is hauled to a mill. At operation 650, the log undergoes milling.

FIG. 6B is a flow chart illustrating an example method 646A for loading a log. At operation 654, a log may be graded. As part of grading, a variation detection model and/or a dimensions estimation model may be used to evaluate multiple poses for the log. The classification for a log may be continuously updated based on these evaluations as further evaluations are performed. In some embodiments, the operation 654 may be performed multiple times, with the operation 654 being performed simultaneously with operations 656, 658.

The analysis engine unit 536 (see FIG. 5) may be configured to grade logs based on the characteristics of the logs, including the dimensions and any variations in logs. The analysis engine unit 536 may be configured to determine or redetermine a grade of a log at a specified frequency. For example, the analysis engine unit 536 may redetermine a grade about one time per second or more, about two times per second or more, etc.

At operation 656, a log may be delimbed. Delimbing may be performed by loading logs into a delimber machine, and the delimber machine may be configured to remove limbs extending outwardly from a body of a log.

At operation 658, a log may be bucked to form one or more smaller logs. In some embodiments, an analysis engine unit 536 (see FIG. 5) may be configured to generate recommendations or instructions for how to buck the log. These recommendations or instructions may be dependent upon the type of wood in the log, the dimensions of the log, detected variations within the log, the anticipated final product that the log will be utilized to create, and/or other factors.

At operation 660, logs may be sorted. This sorting may occur based on a grade and/or a classification that is provided for logs. At operation 662, logs may be loaded so that they may be transported to another location for storage or use. In some embodiments, the method 646A may be performed in place of operation 646 of FIG. 6A.

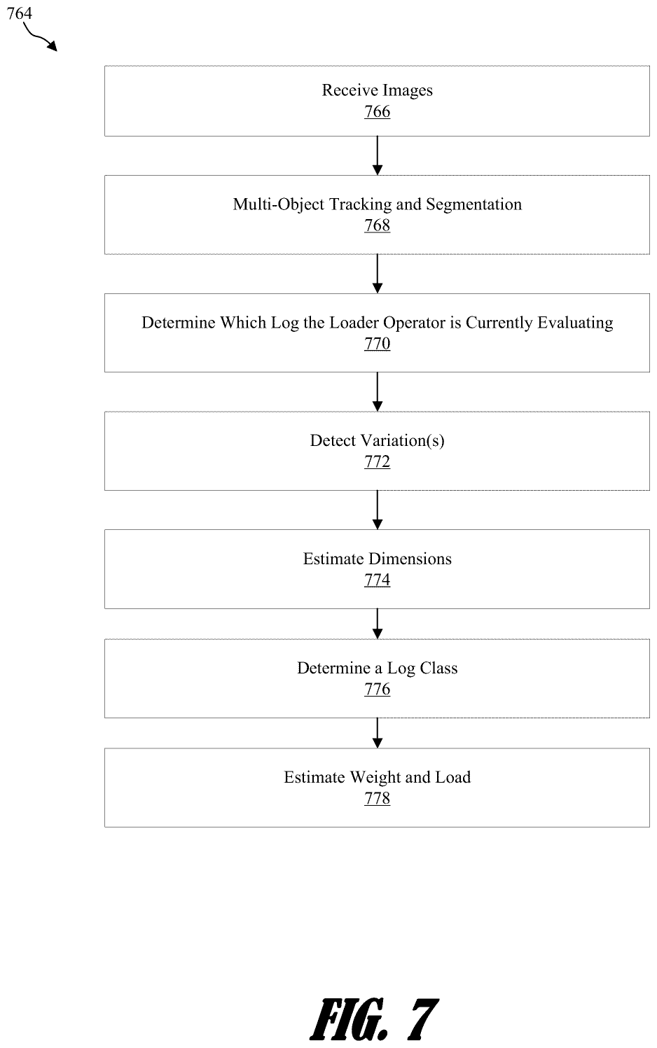

FIG. 7 is a flow chart illustrating an example method 764 for operating a log processing system. In some embodiments, an analysis engine unit 536 (see FIG. 5) of the log processing system 525 (see FIG. 5) consumes frames from video captured during a logging operation and outputs a product class for a log. One example analysis flow for the analysis engine unit 536 is illustrated in FIG. 7.

At operation 766, images may be received. These images may be received, directly or indirectly, from a camera such as a video camera. At operation 768, multi-object tracking and segmentation (MOTS) may be completed. MOTS models establish bounding boxes on objects, classify objects, establish detailed pixel-level segmentation of objects, and track objects between frames. In some embodiments, MOTS may be completed by a MOTS model of an analysis engine unit 536 (see FIG. 5). Further details regarding MOTS and MOTS models are described elsewhere herein.

At operation 770, a determination may be made regarding the log that the loader operator is currently evaluating. This determination may be made using a LUE model of an analysis engine unit 536 (see FIG. 5). The LUE model may utilize bounding boxes and object classes from the MOTS model to identify the specific log that is being evaluated. There may be multiple logs and other objects within the field-of-view and the MOTS model will detect them all. As such, a LUE model is important to distinguish a particular log. Systems described herein may use an algorithm that uses context derived from the video to identify the log-under-evaluation. The output may be a tracking identification and segmentation mask for the log-under-evaluation.

At operation 772, variations may be detected within a log. This may be done using a variation detection model of an analysis engine unit 536 (see FIG. 5) in some embodiments. Further details regarding a variation detection model are described herein.

At operation 774, dimensions may be estimated. In some embodiments, dimensions may be estimated using a dimensions estimation model of an analysis engine unit 536 (see FIG. 5). Further details regarding a dimensions estimation model are described herein. Multiple dimensional characteristics may be estimated for a log-under-evaluation based on context, with this context being derived from video images and segmentation masks from the MOTS model.

At operation 776, a log class may be determined. This may be done using a LC model of an analysis engine unit 536 (see FIG. 5) in some embodiments. Further details regarding a LC model are described herein. In some embodiments, the log class may be repeatedly determined so that the log class may be optimized as further information is obtained about a log under evaluation.

At operation 778, a weight and load of a log may be estimated. This may be done using a WLT model of an analysis engine unit 536 (see FIG. 5) in some embodiments. Further details regarding a WLT model are described herein. In some embodiments, the weight and load of a log may be estimated simultaneously with other operations (e.g., operations 772, 774, 776), and this estimation may occur throughout the time period that the method 764 is performed.

The methods 640, 646A, 764 described herein are merely exemplary, and these methods may be modified in a variety of ways. For example, the operations of the methods may be performed in different orders, some of the operations may be performed simultaneously, additional operations may be added, or operations may be removed from the method. For example, in method 646A of FIG. 6B, operation 658 may be performed before operation 656 so that bucking occurs before delimbing, which may be beneficial depending on the situation.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A log processing system for analyzing a log under evaluation comprising:
a camera;
one or more processors;
one or more memory devices, the memory devices comprising computer readable code configured, when executed, to cause the one or more processors to:
receive images from the camera;
identify the log under evaluation within the images;
estimate dimensions of the log under evaluation; and
determine a log class for the log under evaluation.

2. The log processing system of claim 1, wherein the computer readable code is configured, when executed, to cause the one or more processors to utilize one or more machine learning techniques.

3. The log processing system of claim 2, wherein the computer readable code is configured, when executed, to cause the one or more processors to utilize one or more machine learning techniques to perform at least one of:
identifying the log under evaluation within the images;
estimating the dimensions of the log under evaluation;
determining the log class for the log under evaluation;
detecting and classifying a variation within the log under evaluation;
detecting and classifying an object within the images using multi-object tracking and segmentation; and
tracking of a weight for a log.

4. The log processing system of claim 2, wherein the dimensions of the log under evaluation are determined using photogrammetry.

5. The log processing system of claim 4, wherein the dimensions of the log under evaluation are determined with a dimensional precision of about 0.5 inches or less at a visual depth of about 30 feet from the camera.

6. The log processing system of claim 5, wherein the dimensions of the log are detected within less than about one second of initial observation by the camera.

7. The log processing system of claim 1, wherein the computer readable code is configured, when executed, to cause the one or more processors to sort the log under evaluation based on the log class.

8. The log processing system of claim 1, wherein the computer readable code is configured, when executed, to cause the one or more processors to detect one or more variations in the log under evaluation.

9. The log processing system of claim 8, wherein the one or more variations include a feature that deviates from a conical frustrum shape, a defect, a surface variation, a crook, a sweep, or a fork.

10. The log processing system of claim 1, wherein the computer readable code is configured, when executed, to cause the one or more processors to detect the log under evaluation within a work area using multi-object tracking and segmentation.

11. The log processing system of claim 10, wherein the computer readable code is configured, when executed, to cause the one or more processors to detect another moving object within the work area using multi-object tracking and segmentation.

12. The log processing system of claim 1, wherein the computer readable code is configured, when executed, to cause the one or more processors to estimate a weight of each log, wherein the determination of the log class for the log under evaluation is dependent upon the weight that is estimated.

13. The log processing system of claim 1, wherein the computer readable code is configured, when executed, to cause the one or more processors to use Bayesian updating to determine the log class for the log under evaluation.

14. The log processing system of claim 1, wherein the computer readable code is configured, when executed, to cause the one or more processors to emphasize a representation of the log under evaluation within a display image and to cause the display image to be presented on a display, and wherein the computer readable code is configured, when executed, to cause the one or more processors to cause detailed information regarding the log under evaluation to be presented in the display.

15. A system for analyzing a log under evaluation, the system comprising:
logging equipment, wherein the logging equipment is at least one of a loader, bucking equipment configured to cut a log into one or more smaller logs, and a delimber configured to remove limbs from the log;
a camera;
a log processing system comprising:
one or more processors;
one or more memory devices, the memory devices comprising computer readable code configured, when executed, to cause the one or more processors to:
receive images from the camera;
identify the log under evaluation within the images;
estimate dimensions of the log under evaluation; and
determine a log class for the log under evaluation.

16. The system of claim 15, wherein the logging equipment includes the loader, wherein the computer readable code is configured, when executed, to cause the one or more processors to send loading instructions to the loader and to cause the logging equipment to load the logs in accordance with the loading instructions.

17. The system of claim 16, wherein the logging equipment includes the bucking equipment, wherein the computer readable code is configured, when executed, to cause the one or more processors to send bucking instructions to the bucking equipment and to cause the bucking equipment to cut the log in accordance with the instructions.

18. The system of claim 15, further comprising:
a display,
wherein the computer readable code is configured, when executed, to cause the one or more processors to emphasize a representation of the log under evaluation within a display image and to cause the display image to be presented on the display.

19. A method for analyzing a log under evaluation, the method comprising:
receiving images from the camera;
identifying the log under evaluation within the images;
estimating dimensions of the log under evaluation; and
determining a log class for the log under evaluation.

20. The method of claim 19, further comprising:
detecting the log under evaluation within a work area using multi-object tracking and segmentation;
detecting one or more variations in the log under evaluation;
estimating a weight of each log; and
causing the log under evaluation to be sorted based on the log class,
wherein the determination of the log class for the log under evaluation is dependent upon the weight that is estimated, the type of variations in the log under evaluation, the number or size of variations in the log under evaluation.
